(19) United States
(12) Patent Application Publication
(10) Pub. No.: US 2026/0129292 A1
(43) Pub. Date: May 7, 2026

(54) Hybrid Auto-Focus System with Robust Macro Object Priority Focusing

(71) Applicant: Google LLC, Mountain View, CA (US)

(72) Inventors: Mark Gamadia, Los Gatos, CA (US); Minchieh Wang, San Jose, CA (US); Jae Soo Kim, San Diego, CA (US); Yang Yang, San Jose, CA (US); Ying Chen Lou, Santa Clara, CA (US)

(21) Appl. No.: 19/118,061

(22) PCT Filed: Oct. 2, 2023
(86) PCT No.: PCT/US2023/034281

§ 371 Date: Apr. 3, 2025

Related U.S. Application Data
(60) Provisional application No. 63/378,652, filed on Oct. 6, 2022.

(51) Int. Cl. H04N 23/67; G02B 7/28; G02B 7/40; H04N 23/667; H04N 23/69; H04N 23/959

(52) U.S. Cl. CPC H04N 23/671; G02B 7/282; G02B 7/40; H04N 23/667; H04N 23/672; H04N 23/69; H04N 23/959

(57) ABSTRACT

An example method includes displaying a zoomed preview of a scene captured by a camera system. The method includes determining a phase-detect auto-focus (PDAF) depth estimate and a time-of-flight (ToF) depth estimate for the scene. The method includes, based on a comparison of the PDAF and ToF depth estimates, determining whether a foreground object in the zoomed preview is in-focus for a ToF based AF mode. The method includes, based on a determination that the foreground object in the zoomed preview is in-focus for the ToF based AF mode, bypassing a PDAF mode and activating the ToF based AF mode to focus on the foreground object. The method includes displaying, based on the ToF based AF mode, the focused foreground object as part of the zoomed preview of the scene.

### CROSS-REFERENCE TO RELATED APPLICATIONS/INCORPORATION BY REFERENCE

This application claims priority to U.S. Provisional Patent Application No. 63/378,652, filed on Oct. 6, 2022, which is hereby incorporated by reference in its entirety.

### BACKGROUND

Many modern computing devices, including mobile phones, personal computers, and tablets, include image capture devices. Some image capture devices are configured with multi-camera systems. The camera systems are configured to use their respective specifications to collaboratively meet different image capturing requirements. A smart phone can integrate multiple types of cameras with a variety of focal lengths to take care of objects in different distances and scenes in different fields of view (FOVs).

### SUMMARY

The present disclosure generally relates to a transition between multiple cameras. In one aspect, an image capture device may include multiple cameras. Transitioning from a normal mode to a macro mode may result in a perceptible lack of focus of target close-up objects. As described herein, a priority hybrid auto-focus strategy is described, thereby reducing the perceptible lack of focus subsequent to a camera switch (e.g., to an ultra-wide camera).

In a first aspect, a computer-implemented method is provided. The method includes displaying, by a display screen of a camera system, a zoomed preview of a scene captured by the camera system. The method includes determining a phase-detect autofocus (PDAF) depth estimate and a time-of-flight (ToF) depth estimate for the scene. The method includes, based on a comparison of the PDAF depth estimate and the ToF depth estimate, determining whether a foreground object in the zoomed preview is in-focus for a ToF based autofocus (AF) mode of the camera system. The method includes, based on a determination that the foreground object in the zoomed preview is in-focus for the ToF based AF mode, bypassing a PDAF mode and activating the ToF based AF mode to focus on the foreground object, wherein the PDAF mode comprises focusing of the camera system based on the PDAF depth estimate, and wherein the ToF based AF mode comprises focusing of the camera system based on the ToF depth estimate. The method includes displaying, by the display screen and based on the ToF based AF mode, the focused foreground object as part of the zoomed preview of the scene.

In a second aspect, a computing device is provided. The computing device includes a display screen, a camera system configured to operate at a focal length less than a threshold focal length, one or more processors, and data storage, wherein the data storage has stored thereon computer-executable instructions that, when executed by the one or more processors, cause the mobile device to carry out functions. The operations include displaying, by a display screen of the camera system, a zoomed preview of a scene captured by the camera system; receiving, based on the zoomed preview of the scene, a phase-detect autofocus (PDAF) depth estimate and a time-of-flight (ToF) depth estimate for the scene; based on a comparison of the PDAF depth estimate and the ToF depth estimate, determining whether a foreground object in the zoomed preview is in-focus for a ToF based AF mode of the camera system; based on a determination that the foreground object in the zoomed preview is in-focus for the ToF based AF mode, bypassing a PDAF mode and activating the ToF based AF mode to focus on the foreground object, wherein the PDAF mode comprises focusing of the camera system based on the PDAF depth estimate, and wherein the ToF based AF mode comprises focusing of the camera system based on the ToF depth estimate; and displaying, by the display screen and based on the ToF based AF mode, the focused foreground object as part of the zoomed preview of the scene.

In a third aspect, an article of manufacture is provided. The article of manufacture may include a non-transitory computer-readable medium comprising program instructions executable by one or more processors to cause the one or more processors to perform operations. The operations include displaying, by a display screen of a camera system, a zoomed preview of a scene captured by the camera system; determining a phase-detect autofocus (PDAF) depth estimate and a time-of-flight (ToF) depth estimate for the scene; based on a comparison of the PDAF depth estimate and the ToF depth estimate, determining whether a foreground object in the zoomed preview is in-focus for a ToF based AF mode of the camera system; based on a determination that the foreground object in the zoomed preview is in-focus for the ToF based AF mode, bypassing a PDAF mode and activating the ToF based AF mode to focus on the foreground object, wherein the PDAF mode comprises focusing of the camera system based on the PDAF depth estimate, and wherein the ToF based AF mode comprises focusing of the camera system based on the ToF depth estimate; and displaying, by the display screen and based on the ToF based AF mode, the focused foreground object as part of the zoomed preview of the scene.

In a fourth aspect, a system is provided. The system includes means for displaying, by a display screen of a camera system, a zoomed preview of a scene captured by the camera system; means for determining a phase-detect autofocus (PDAF) depth estimate and a time-of-flight (ToF) depth estimate for the scene; based on a comparison of the PDAF depth estimate and the ToF depth estimate, means for determining whether a foreground object in the zoomed preview is in-focus for a ToF based AF mode of the camera system; based on a determination that the foreground object in the zoomed preview is in-focus for the ToF based AF mode, means for bypassing a PDAF mode and activating the ToF based AF mode to focus on the foreground object, wherein the PDAF mode comprises focusing of the camera system based on the PDAF depth estimate, and wherein the ToF based AF mode comprises focusing of the camera system based on the ToF depth estimate; and means for displaying, by the display screen and based on the ToF based AF mode, the focused foreground object as part of the zoomed preview of the scene.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 is an illustration of front, right-side, and rear views of a digital camera device, in accordance with example embodiments.

FIG. 2 is an illustration of a preview frame displaying a user-friendly mode switch option, in accordance with example embodiments.

FIG. 3 is an illustration of example images with and without the hybrid AF based macro object focusing, in accordance with example embodiments.

FIG. 4 is an illustration of example images with and without the hybrid AF based macro object focusing, in accordance with example embodiments.

FIG. 5 is an illustration of example images with and without the hybrid AF based macro object focusing, in accordance with example embodiments.

FIG. 6 is an illustration of example images with and without the hybrid AF based macro object focusing, in accordance with example embodiments.

FIG. 7 is an example workflow for a hybrid auto-focus system with robust macro object priority focusing, in accordance with example embodiments.

FIG. 8A is another example workflow for a hybrid auto-focus system with robust macro object priority focusing, in accordance with example embodiments.

FIG. 8B is an illustration of a multi-grid contrast detection autofocus (CDAF) analysis, in accordance with example embodiments.

FIG. 9 depicts a distributed computing architecture, in accordance with example embodiments.

FIG. 10 is a block diagram of a computing device, in accordance with example embodiments.

FIG. 11 is a flowchart of a method, in accordance with example embodiments.

FIG. 12 illustrates a difference in image focusing with and without the hybrid AF based macro object focusing, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

A smart phone or other mobile device that supports image and/or video capture may be equipped with multiple cameras using respective specifications to collaboratively meet different image capturing requirements. A smart phone can integrate multiple types of cameras with a variety of focal lengths to display and/or capture objects at different distances, and scenes in different fields of view (FOVs).

Cameras are devices used to capture images of a scene. Some cameras (e.g., film cameras) chemically capture an image on film. Other cameras (e.g., digital cameras) electrically capture image data (e.g., using a charge-coupled device (CCD) or complementary metal-oxide-semiconductor (CMOS) sensors). In order to most accurately capture the scene, a camera may be focused on one or more subjects in the scene. There are multiple ways to focus a camera. For example, a lens of the camera can be moved relative to an image sensor of the camera to adjust the focus of the camera (e.g., to bring one or more subjects in focus). Similarly, an image sensor of the camera can be moved relative to the lens of the camera to adjust the focus of the camera.

Adjusting the focus of a camera can be performed manually (e.g., by a photographer). Alternatively, an autofocus procedure can be performed to adjust the focus of a camera prior to capturing an image (e.g., a payload image). Autofocus procedures may use one or more images (either captured by the primary image sensor of the camera or one or more auxiliary sensors in the camera) to determine an appropriate focus setting for the camera. Then, based on the determined focus setting, the camera adjusts to meet that focus setting. For example, a motor may adjust the relative position of the lens and/or the image sensor to meet the determined focus setting.

There are two traditional types of autofocus procedures, active autofocus procedures and passive autofocus procedures.

In active autofocus procedures, a rangefinder (e.g., a laser rangefinder, a radar device, or a sonar device) is used to determine a distance to one or more objects within a scene. Then, based on the determined distance, a focus setting is determined and the camera is adjusted to meet the determined focus setting.

There are two primary species of passive autofocus procedures, phase-detection autofocus and contrast-detection autofocus.

In phase-detection autofocus (PDAF), incoming light from the scene is divided (e.g., by a beamsplitter) such that light from the scene entering one side of the lens of the camera is physically separated on an image sensor (e.g., the primary image sensor of the camera or an auxiliary image sensor) from light from the scene entering the opposite side of the lens. Based on the camera characteristics (e.g., lens size, lens focal length, and lens location relative to the image sensor) and the light intensity distribution across the various locations on the image sensor, a focus setting can be determined. Like with active autofocus procedures, the camera can be adjusted to meet the determined focus setting.

In contrast-detection autofocus (CDAF), a series of frames are captured by the camera at a corresponding series of different focus settings. The contrast between high intensity and low intensity is then determined for each of the captured frames. Based on the determined contrasts, a focus setting is determined (e.g., based on the frame with the highest contrast and/or based on a regression analysis using the contrasts of the captured frames). Similar to the active autofocus procedures and phase-detection autofocus, the camera can be adjusted to meet the determined focus setting.

Unlike active autofocus procedures, passive autofocus procedures (e.g., phase-detection autofocus and contrast-detection autofocus) do not use additional rangefinding equipment. Hence, passive autofocus procedures may be employed in camera systems to save on cost (e.g., in a mobile phone or a digital single-lens reflex (DSLR) camera). However, passive autofocus procedures may be less successful in low-light conditions (e.g., because insufficient contrast is generated between frames for use in contrast-detection autofocus or because there are insufficient bright objects within a scene to compare when using phase-detection autofocus).

A mobile phone may be configured with a main camera with a medium focal length to meet normal photo/video capture requirements, a telescope camera with a longer focal length to capture remote objects, and a wide or an ultra-wide camera with a shorter focal length to capture larger FOVs. During the photo/video capture session, a switch from the main camera to the telescope camera may occur when a user continues to zoom-in for the in-focus of a remote object, and a switch from the main camera to the ultra-wide camera may occur when the user continues to zoom-out to capture a larger field-of-view. Multi-camera systems provide a much larger range of focus distances than a single camera. However, in switching from the wide camera to the ultra-wide camera, it may be challenging to focus on a foreground object, especially against a high contrast background.

For example, in a smartphone camera with a macro mode feature, users generally expect to be able to focus closely on small objects. Close ups of objects often have high contrast backgrounds. Such scenes with traditional hybrid autofocus (AF) schemes may tend to back-focus and may not automatically achieve the desired focus point for the user.

Generally, it is desirable that each image captured by a user is detailed, in focus, worthy of being saved and shared. It is also desirable for a user to have control over when they wish to enable this functionality so that it is beneficial to their camera experience. Accordingly, auto switching cameras at an appropriate time, dynamically choosing the right lens for the user to obtain the best image quality, providing the user with helpful prompts, and enhancing the image post capture are significant aspects for this feature to provide an optimal functionality. Also, for example, traditional camera systems generally have the macro mode embedded deep in the hardware configuration, and the features are available to an advanced user, such as a professional photographer. Accordingly, making macro mode available in a user-friendly manner is another aspect of the procedures described herein.

To make this process user-friendly, a hybrid auto-focus strategy that prioritizes a macro object may be deployed. For example, a traditional hybrid AF strategy hierarchy involves applying a phase-detect autofocus (PDAF) algorithm, followed by a time-of-flight (ToF) based algorithm, and a contrast detection autofocus (CDAF) algorithm. However, despite a high level of confidence on a PDAF based depth estimate, the PDAF algorithm may cause a camera lens to focus on the background, and a foreground object may therefore remain out-of-focus. Accordingly, there is a need to override the PDAF algorithm to be able to bring the foreground object into sharper focus, as described herein.

In addition to focusing on foreground objects, the techniques described herein enable photography of objects as close as 3 cms. away. When combined with HDR+ quality processing, fine objects such as rain drops, individual flower petals, grains of pollen, and so forth, can be brought into sharp focus. For example, the techniques described herein enable photography of objects such as small living objects, such as, plants, pets, insects, human eyes, animal eyes, feathers, mushrooms, and so forth. The techniques described herein also enable sharper image capturing for unique textures such as jeans, leather, cotton, any kind of fabric, stone, brick, rough surfaces, smooth surfaces, rust, paint, tissue fabric, mouse pads, tin foil, ice cubes, foam, and bubbles. Also, for example, natural subjects, such as fruits, vegetables, water droplets, trees, moss, grass, snowflakes, sea shells, seeds, and so forth can be brought into sharper focus. Generally, any object that may have a distinct appearance, and/or reveal new image information when viewed up close may be brought into sharp focus. Such objects may include, for example, coins, crayon tips, pencil tips, matches, needles, Q Tips, musical instruments, handwriting, paper, fingerprints, buttons, jewelry, floor tiles, and so forth. The macro mode with an ultra-wide camera can be integrated seamlessly with other camera systems providing zoom ratios ranging from 0.5× to 30×.

### Example Camera System

As image capture devices, such as cameras, become more popular, they may be employed as standalone hardware devices or integrated into various other types of devices. For instance, still and video cameras are now regularly included in wireless computing devices (e.g., mobile devices, such as mobile phones), tablet computers, laptop computers, video game interfaces, home automation devices, and even automobiles and other types of vehicles.

The physical components of a camera may include one or more apertures through which light enters, one or more recording surfaces for capturing the images represented by the light, and lenses positioned in front of each aperture to focus at least part of the image on the recording surface(s). The apertures may be fixed size or adjustable. In an analog camera, the recording surface may be photographic film. In a digital camera, the recording surface may include an electronic image sensor (e.g., a charge coupled device (CCD) or a complementary metal-oxide-semiconductor (CMOS) sensor) to transfer and/or store captured images in a data storage unit (e.g., memory).

One or more shutters may be coupled to or nearby the lenses or the recording surfaces. Each shutter may either be in a closed position, in which it blocks light from reaching the recording surface, or an open position, in which light is allowed to reach the recording surface. The position of each shutter may be controlled by a shutter button. For instance, a shutter may be in the closed position by default. When the shutter button is triggered (e.g., pressed), the shutter may change from the closed position to the open position for a period of time, known as the shutter cycle. During the shutter cycle, an image may be captured on the recording surface. At the end of the shutter cycle, the shutter may change back to the closed position.

Alternatively, the shuttering process may be electronic. For example, before an electronic shutter of a CCD image sensor is “opened,” the sensor may be reset to remove any residual signal in its photodiodes. While the electronic shutter remains open, the photodiodes may accumulate charge. When or after the shutter closes, these charges may be transferred to longer-term data storage. Combinations of mechanical and electronic shuttering may also be possible.

Regardless of type, a shutter may be activated and/or controlled by something other than a shutter button. For instance, the shutter may be activated by a softkey, a timer, or some other trigger. Herein, the term “image capture” may refer to any mechanical and/or electronic shuttering process that results in one or more images being recorded, regardless of how the shuttering process is triggered or controlled.

The exposure of a captured image may be determined by a combination of the size of the aperture, the brightness of the light entering the aperture, and the length of the shutter cycle (also referred to as the shutter length, the exposure length, or the exposure time). Additionally, a digital and/or analog gain (e.g., based on an ISO setting) may be applied to the image, thereby influencing the exposure. In some embodiments, the term “exposure length,” “exposure time,” or “exposure time interval” may refer to the shutter length multiplied by the gain for a particular aperture size. Thus, these terms may be used somewhat interchangeably, and should be interpreted as possibly being a shutter length, an exposure time, and/or any other metric that controls the amount of signal response that results from light reaching the recording surface.

In some implementations or modes of operation, a camera may capture one or more still images each time image capture is triggered. In other implementations or modes of operation, a camera may capture a video image by continuously capturing images at a particular rate (e.g., 24 frames per second) as long as image capture remains triggered (e.g., while the shutter button is held down). Some cameras, when operating in a mode to capture a still image, may open the shutter when the camera device or application is activated, and the shutter may remain in this position until the camera device or application is deactivated. While the shutter is open, the camera device or application may capture and display a representation of a scene on a viewfinder (sometimes referred to as displaying a “preview frame”). When image capture is triggered, one or more distinct payload images of the current scene may be captured.

Cameras, including digital and analog cameras, may include software to control one or more camera functions and/or settings, such as aperture size, exposure time, gain, and so on. Additionally, some cameras may include software that digitally processes images during or after image capture. While the description above refers to cameras in general, it may be particularly relevant to digital cameras. Digital cameras may be standalone devices (e.g., a DSLR camera) or may be integrated with other devices.

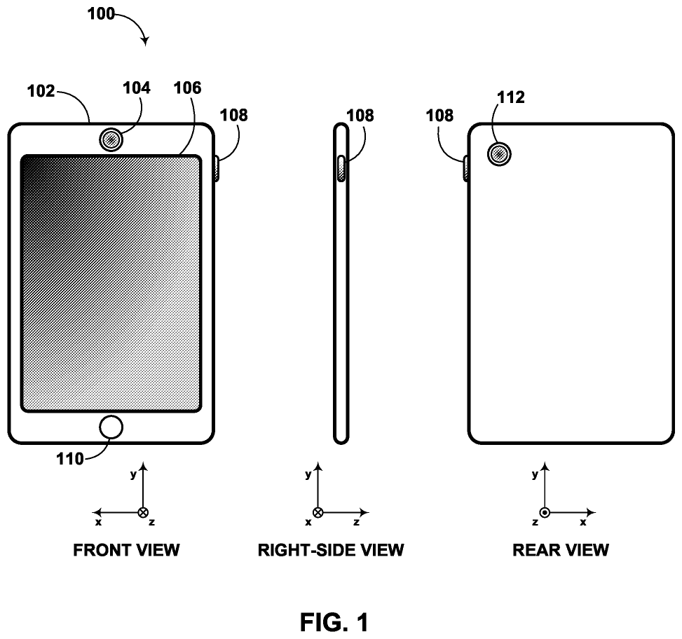

FIG. 1 is an illustration of front, right-side, and rear views of a digital camera device 100, in accordance with example embodiments. Digital camera device 100 may be, for example, a mobile device (e.g., a mobile phone), a tablet computer, or a wearable computing device. However, other embodiments are possible. Digital camera device 100 may include various elements, such as a body 102, a front-facing camera 104, a multi-element display 106, a shutter button 108, and other buttons 110. Digital camera device 100 could further include a rear-facing camera 112. Front-facing camera 104 may be positioned on a side of body 102 typically facing a user while in operation, or on the same side as multi-element display 106. Rear-facing camera 112 may be positioned on a side of body 102 opposite front-facing camera 104. Referring to the cameras as front-facing and rear-facing is arbitrary, and digital camera device 100 may include multiple cameras positioned on various sides of body 102.

Multi-element display 106 could represent a cathode ray tube (CRT) display, a light-emitting diode (LED) display, a liquid crystal display (LCD), a plasma display, or any other type of display known in the art. In some embodiments, multi-element display 106 may display a digital representation of the current image being captured by front-facing camera 104 and/or rear-facing camera 112, or an image that could be captured or was recently captured by either or both of these cameras. Thus, multi-element display 106 may serve as a viewfinder for either camera. Multi-element display 106 may also support touchscreen and/or presence-sensitive functions that may be able to adjust the settings and/or configuration of any aspect of digital camera device 100.

Front-facing camera 104 may include an image sensor and associated optical elements such as lenses. Front-facing camera 104 may offer zoom capabilities or could have a fixed focal length. In other embodiments, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent a monoscopic, stereoscopic, or multiscopic camera. Rear-facing camera 112 may be similarly or differently arranged. Additionally, front-facing camera 104, rear-facing camera 112, or both, may be an array of one or more cameras.

Either or both of front facing camera 104 and rear-facing camera 112 may include or be associated with an illumination component that provides a light field to illuminate a target object. For instance, an illumination component could provide flash or constant illumination of the target object (e.g., using one or more LEDs). An illumination component could also be configured to provide a light field that includes one or more of structured light, polarized light, and light with specific spectral content. Other types of light fields known and used to recover three-dimensional (3D) models from an object are possible within the context of the embodiments herein.

Either or both of front facing camera 104 and rear-facing camera 112 may include or be associated with an ambient light sensor that may continuously or from time to time determine the ambient brightness of a scene that the camera can capture. In some devices, the ambient light sensor can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. Additionally, the ambient light sensor's input may be used to determine an exposure time of an associated camera, or to help in this determination.

Digital camera device 100 could be configured to use multi-element display 106 and either front-facing camera 104 or rear-facing camera 112 to capture images of a target object (i.e., a subject within a scene). The captured images could be a plurality of still images or a video image (e.g., a series of still images captured in rapid succession with or without accompanying audio captured by a microphone). The image capture could be triggered by activating shutter button 108, pressing a softkey on multi-element display 106, or by some other mechanism. Depending upon the implementation, the images could be captured automatically at a specific time interval, for example, upon pressing shutter button 108, upon appropriate lighting conditions of the target object, upon moving digital camera device 100 a predetermined distance, or according to a predetermined capture schedule.

As noted above, the functions of digital camera device 100 (or another type of digital camera) may be integrated into a computing device, such as a wireless computing device, cell phone, tablet computer, laptop computer, and so on. For example, a camera controller may be integrated with the digital camera device 100 to control one or more functions of the digital camera device 100.

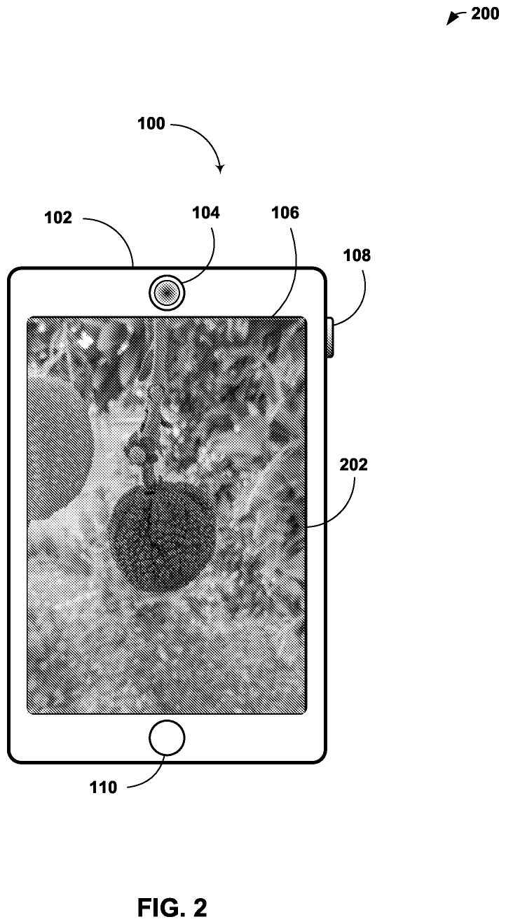

FIG. 2 is an illustration of a preview frame 202 displaying a user-friendly mode switch option, in accordance with example embodiments. The preview frame 202 may display a captured frame to a user based on the current scene being captured using the current camera system settings (e.g., aperture settings, exposure settings, etc.). The techniques described herein may be used when a preview frame appears similar to the preview frame 202 of FIG. 2.

In some embodiments, hybrid autofocus procedures described herein may be triggered when a previous autofocus (e.g., based on a traditional PDAF algorithm) has been unsuccessful. For example, the preview frame 202 illustrated in FIG. 2 may have inadequate focus for a payload image, so the hybrid autofocus procedure may be executed. Whether or not the previous autofocus was unsuccessful could be based on an indication from a user that the previous autofocus was inadequate. In other embodiments, a hybrid autofocus algorithm (e.g., a PDAF algorithm used in preview mode) may provide an indication that the autofocus has failed. For example, the autofocus algorithm may provide a PDAF confidence value that indicates the probability that the autofocus was successful, and if that confidence value is below a certain threshold (e.g., PDAF confidence threshold), it may be determined that the autofocus failed. An indication that the autofocus has failed may be provided by an API (e.g., an API for a camera module of the mobile device).

Whether or not a hybrid autofocus is successful could be based on a hybrid autofocus algorithm (e.g., a time-of-flight (ToF) algorithm used in preview mode) that may provide an indication that the autofocus has succeeded. For example, the autofocus algorithm may provide a ToF confidence value that indicates the probability that the autofocus was successful, and if that confidence value is above a certain threshold (e.g., ToF confidence threshold), it may be determined that the autofocus has succeeded. An indication that the autofocus has succeeded may be provided by an API (e.g., an API for a camera module of the mobile device).

For example, a selectable virtual object can be provided to a user (e.g., during a camera transition from the main camera to the ultra-wide camera, or during an operation of the ultra-wide camera), to indicate whether to enable or disable a hybrid autofocus mode described herein. For example, a toggle switch could be displayed on the multi-element display 106 of the digital camera device 100 to enable or disable the hybrid autofocus mode.

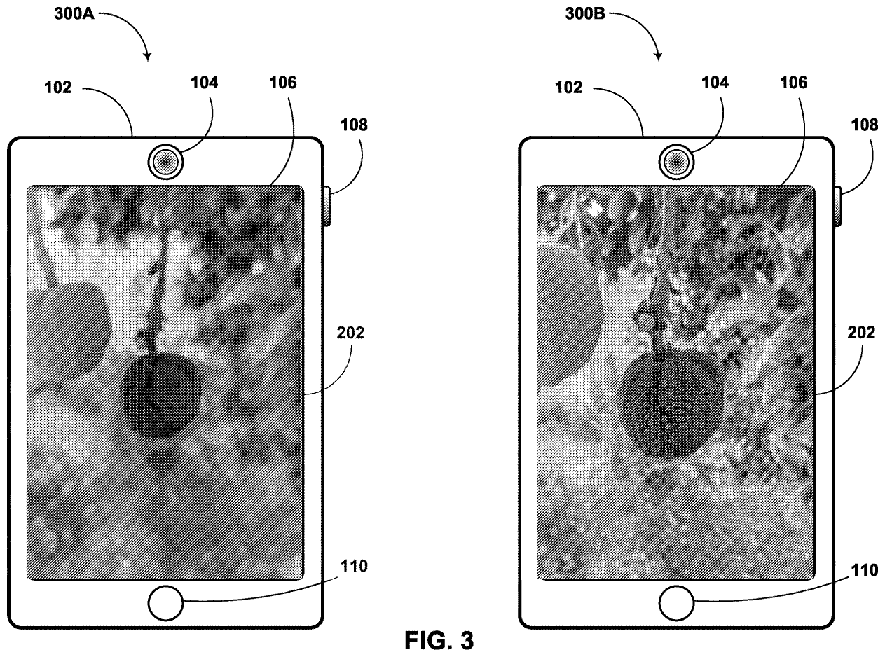

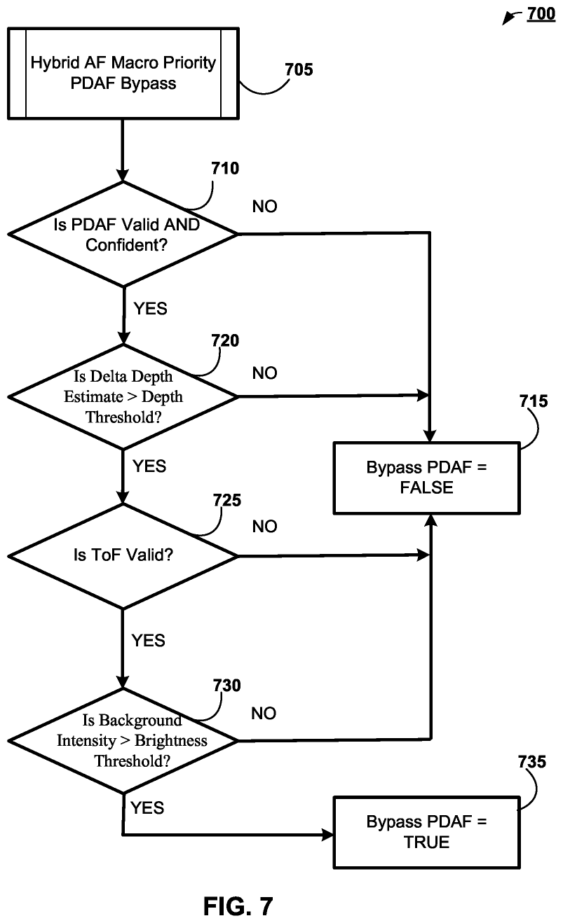

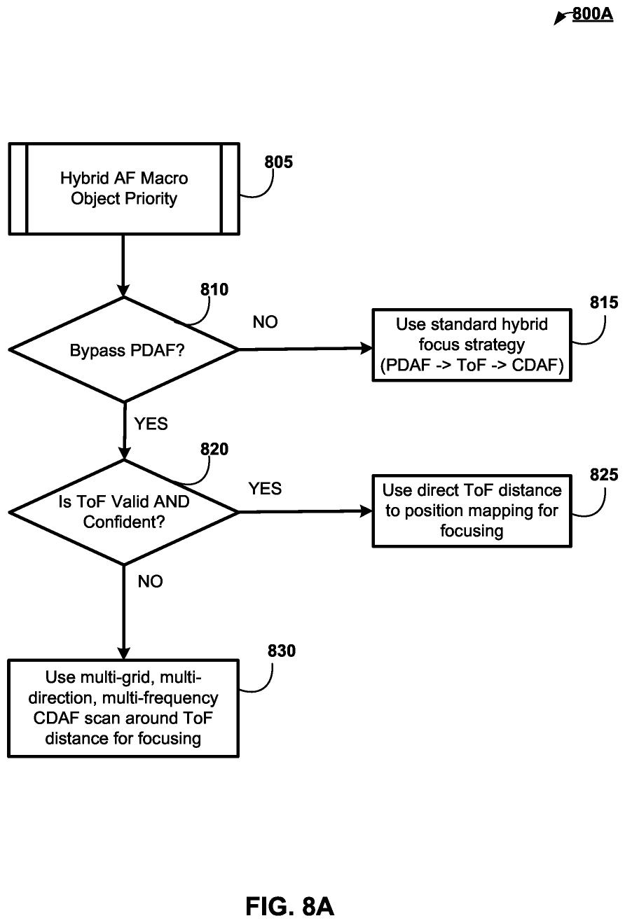

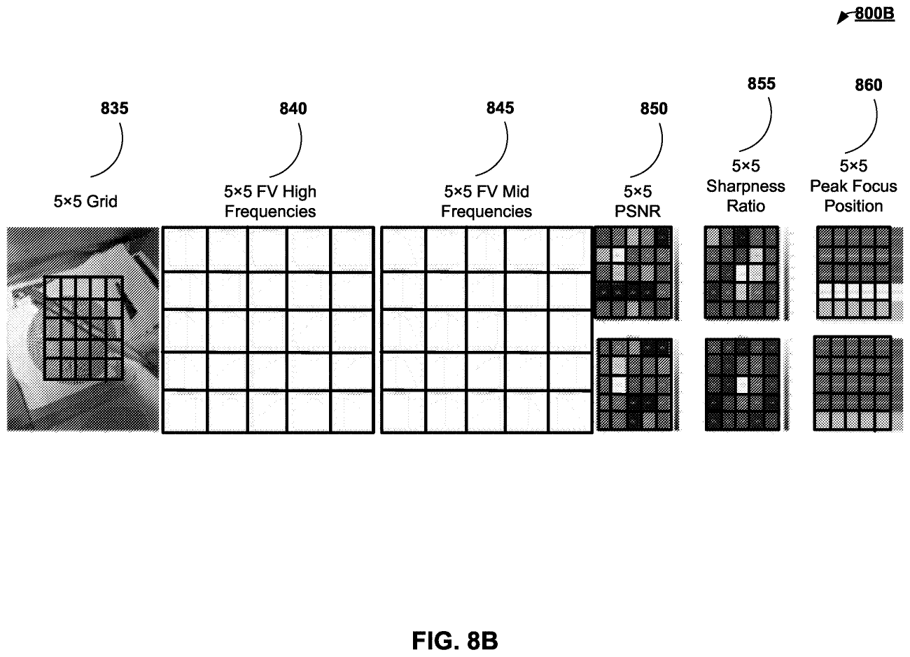

FIG. 3 is an illustration of example images with and without the hybrid AF based macro object focusing, in accordance with example embodiments. FIG. 3 shares one or more aspects in common with FIGS. 1 and 2. Digital camera device 300A illustrates an image where the traditional PDAF approach is used to capture the image. As illustrated, one or more foreground objects may be out-of-focus. Digital camera device 300B illustrates a situation where hybrid AF based macro object focusing is used. Accordingly, the algorithms described with reference to FIGS. 7 and 8 are applied, and one or more foreground objects may be brought in-focus. For example, a ToF based AF mode may be applied (e.g., a multi-grid, multi-direction, multi-frequency CDAF scan based on the ToF distance, as described with reference to block 830 of FIG. 8).

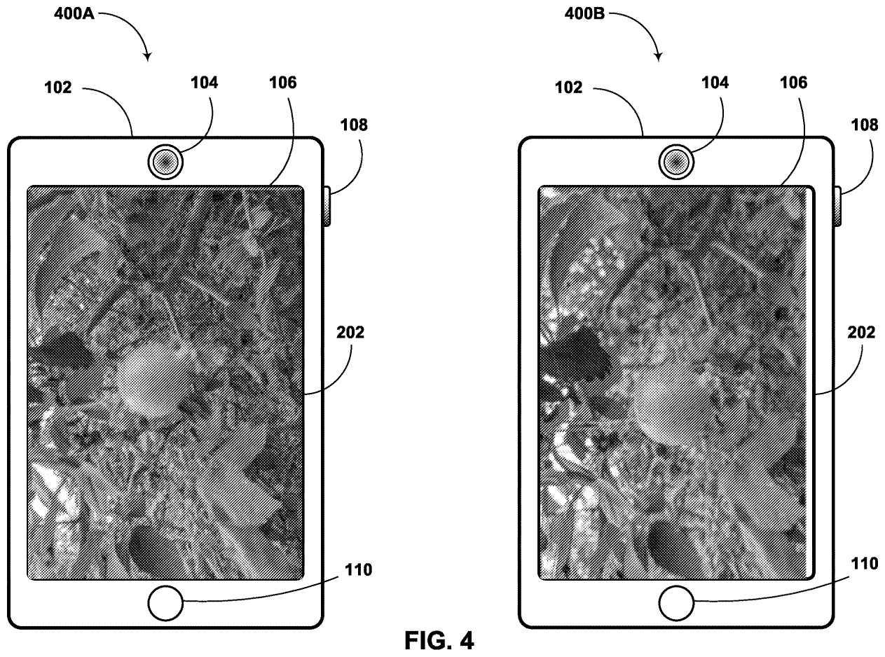

FIG. 4 is an illustration of example images with and without the hybrid AF based macro object focusing, in accordance with example embodiments. FIG. 4 shares one or more aspects in common with FIGS. 1-3. Digital camera device 400A illustrates an image where the traditional PDAF approach is used to capture the image. As illustrated, one or more foreground objects may be out-of-focus. Digital camera device 400B illustrates a situation where hybrid AF based macro object focusing is used to capture the image. Accordingly, the algorithms described with reference to FIGS. 7 and 8 are applied, and one or more foreground objects may be brought in-focus. For example, a ToF based AF mode may be applied (e.g., a multi-grid, multi-direction, multi-frequency CDAF scan based on the ToF distance, as described with reference to block 830 of FIG. 8).

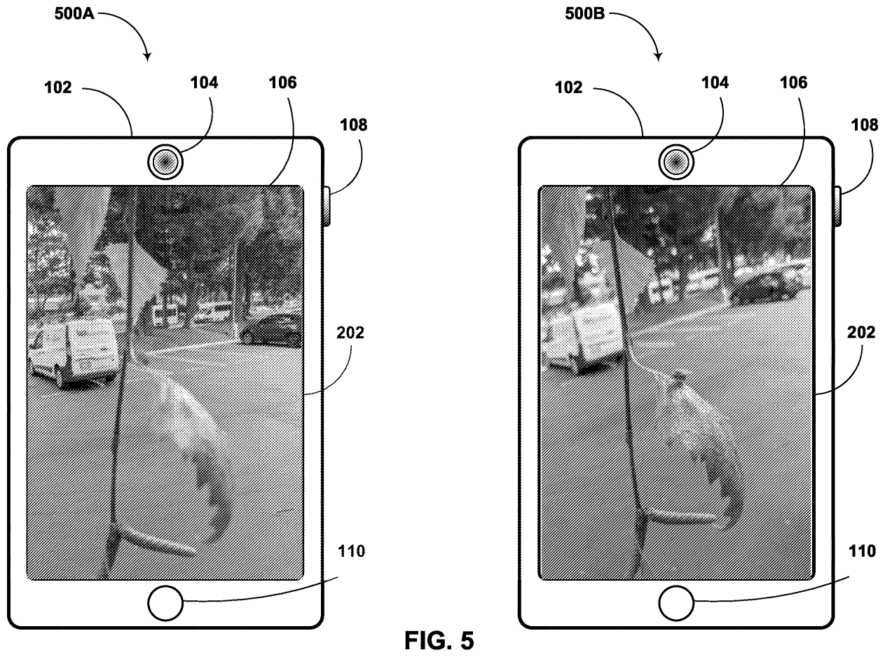

FIG. 5 is an illustration of example images with and without the hybrid AF based macro object focusing, in accordance with example embodiments. FIG. 5 shares one or more aspects in common with FIGS. 1-4. Digital camera device 500A illustrates an image where the traditional PDAF approach is used to capture the image. As illustrated, one or more foreground objects may be out-of-focus. Digital camera device 500B illustrates a situation where hybrid AF based macro object focusing is used to capture the image. Accordingly, the algorithms described with reference to FIGS. 7 and 8 are applied, and one or more foreground objects may be brought in-focus. For example, a ToF based AF mode may be applied (e.g., a multi-grid, multi-direction, multi-frequency CDAF scan based on the ToF distance, as described with reference to block 830 of FIG. 8).

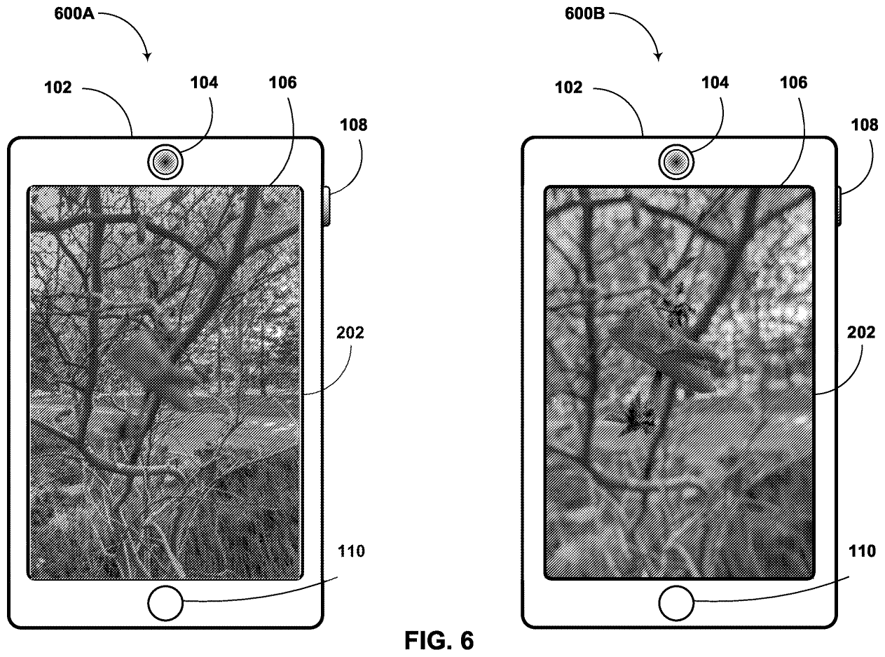

FIG. 6 is an illustration of example images with and without the hybrid AF based macro object focusing, in accordance with example embodiments. FIG. 6 shares one or more aspects in common with FIGS. 1-5. Digital camera device 600A illustrates an image where the traditional PDAF approach is used to capture the image. As illustrated, one or more foreground objects may be out-of-focus. Digital camera device 600B illustrates a situation where hybrid AF based macro object focusing is used to capture the image. Accordingly, the algorithms described with reference to FIGS. 7 and 8 are applied, and one or more foreground objects may be brought in-focus. For example, a ToF based AF mode may be applied (e.g., a multi-grid, multi-direction, multi-frequency CDAF scan based on the ToF distance, as described with reference to block 830 of FIG. 8).

### Hybrid AF Algorithm for Macro Mode

Traditional hybrid AF schemes prioritize PDAF−> TOF−> CDAF based on a PDAF confidence. PDAF is an efficient method for continuous focusing of the camera, as it relies on the disparity information derived from the image sensor, and directly controls the lens to optimize the blur circle projected on the image sensor for the AF region of interest (ROI). In the event PDAF is confident, it is used to drive focus. In some cases, such as low light situations, PDAF disparity estimation may break down due to noise from lower SNR. In such conditions, ToF may be a good complement to use for focusing using an estimate of metric depth of the scene translated to focus lens position via depth-to-position mapping. However, this mapping may have accuracy issues, it may therefore be followed up with some contrast scanning (e.g., CDAF) to close the accuracy gap. Finally, if ToF is not confident or not valid, the AF system would rely on CDAF scanning as a last resort. Generally, CDAF requires focus scanning and is not optimal for fast moving subjects.

Thus, in traditional hybrid AF systems, if PDAF is confident, it is directly used to drive focus and a decision to set the focus point is not overridden by the other focus point data available. However, this scheme may be sub-optimal for macro mode with small and/or thin objects versus a high contrast background, leading to undesirable back-focus. Also, for example, an image quality based on a PDAF mode may not be sufficient to view close objects. For example, a sparse PDAF may fail to detect a close object (e.g., a foreground object).

Phase-detection autofocus is a passive autofocus technique that attempts to determine a proper focus setting of a camera system (e.g., a position of a lens and/or a position of an image sensor) based on the subjects within a scene of a surrounding environment that will ultimately be captured in a payload image. Phase-detection autofocus functions by splitting light that enters the camera system into two or more portions. Those portions may be captured and then compared to one another. The two or more portions are compared to determine relative locations of intensity peaks and valleys across the respective frames. If the relative locations within the frame match, the subject(s) of the scene are in focus. If the relative locations do not match, then the subject(s) of the scene are out of focus. Based on the distance between respective peaks and respective valleys and the position of optics within the camera system (e.g., the lens, image sensor(s), etc.), adjustments can be determined that would move the subject(s) into focus.

Further, in some embodiments, one or more objects in the scene may be in focus while others remain out of focus. Hence, determining whether the scene is out of focus may include selecting one or more subjects in the scene upon which to make the determination. A region of interest for focus determination may be selected based on a user (e.g., of a mobile device). For example, the user may select an object in a preview frame that the user desires to be in focus (e.g., a building, a person, the face of a person, a car, etc.). Alternatively, an object-identification algorithm may be employed to determine what type of objects are in a scene and determine which of the objects should be in focus based on a list ranked by importance (e.g., if a human face is in the scene, that should be the object in focus, followed by a dog, followed by a building, etc.). In still other embodiments, whether the scene is in focus or out of focus may include identifying whether an object that is moving within a scene (e.g., as determined by preview frames) is in focus or not. Alternatively, determining an “in focus” camera setting could include determining the lens setting at which a maximized region of the frame (e.g., by pixel area) is in focus or a maximized number of subjects (e.g., one discrete object, two discrete objects, three discrete objects, four discrete objects, etc.) within the frame are in focus.

Generally, the ToF focusing is an active autofocus technique, where the camera can measure target distances by actively illuminating an object. The illumination may be performed using light sources such as an LED or a laser. The light reflected by the object is captured with a ToF sensor. Generally, the ToF sensor is configured to be sensitive to different wavelengths, and the ToF sensor can measure a time delay in the light being reflected back to the sensor, and a ToF depth estimate may be determined based on the time delay. For example, the time delay, AT, is generally proportional to twice the distance from the camera to the object, corresponding to a round-trip distance from when the light leaves the camera, gets reflected, and returns to the camera. Accordingly, the ToF depth estimate, d, may be determined as d=k ΔT/2, where k is a constant of proportionality.

As described herein, a hybrid AF macro object priority scheme prioritizes ToF based AF mode over PDAF mode to help users with focusing close objects in macro mode. This approach applies even in situations where the brightness level of the scene exceeds a threshold level, and the PDAF estimate is valid and is confident. In such cases, traditional camera systems use the PDAF mode to drive focus.

However, in some embodiments, the ToF focusing may have ranging accuracy loss in bright light situations, and there may be a spatial parallax shift in the camera FOV at closer object distances. Accordingly, when the TOF depth estimate is not confident enough to drive focus by itself, the ToF based AF mode may be configured to constrain a focus scan around a TOF estimated focus position with a multi-grid CDAF search to help pinpoint the focus position, and thereby overcome the ambiguities in the focus data available to the traditional AF algorithm.

FIG. 7 is an example workflow 700 for a hybrid auto-focus system with robust macro object priority focusing, in accordance with example embodiments. As illustrated, a PDAF bypass determination module 705 may be initiated. For example, this may be initiated based on a user indication, or automatically determined based on camera sensor data (e.g., called by hybrid AF macro object priority module 805 of FIG. 8). The term “ToF based AF mode” as used herein, generally refers to an operation performed at step 825 and/or step 830 of FIG. 8. Also, for example, the term “PDAF mode” as used herein, generally refers to a mode that runs the traditional PDAF algorithm.

At step 710, the process involves determining whether a PDAF depth estimate is valid, and if the PDAF depth estimate exceeds a PDAF confidence threshold. Generally, PDAF pixels work by capturing two slightly different views of a scene. A parallax effect, where an object remains stationary whereas the background moves horizontally, may be used to estimate PDAF depth. For example, parallax is a function of a point's distance from the camera and the distance between two viewpoints. Accordingly, PDAF depth estimate can be performed by matching each point in one view with its corresponding point in the other view. However, finding these correspondences in PDAF images (i.e. determining depth from stereo) can be a challenging task because scene points barely move between the views. Also, for example, stereo techniques may involve an aperture problem (i.e., when a scene is viewed through a small aperture, it may not always be possible to find correspondences for lines parallel to the stereo baseline, i.e., the line connecting the two cameras. Accordingly, the PDAF estimate may sometimes be erroneous.

Upon a determination that the PDAF depth estimate is not valid (i.e., is erroneous), or that the PDAF depth estimate fails to exceed the PDAF confidence threshold, the process proceeds to step 715, and the “Bypass PDAF” parameter is set to “FALSE” indicating that the PDAF mode remains active (e.g., PDAF mode is maintained, is not bypassed, etc.), and a ToF based AF mode is not activated.

Upon a determination that the PDAF depth estimate exceeds the PDAF confidence threshold, the process proceeds to step 720.

At step 720, the process involves a comparison of the PDAF depth estimate and the ToF depth estimate to determine whether a foreground object in the zoomed preview is in-focus for a ToF based AF mode of the camera system (and likely out-of-focus for the PDAF mode). For example, the comparison of the PDAF depth estimate and the ToF depth estimate involves determining whether a delta depth estimate based on a difference between the PDAF depth estimate and the ToF depth estimate exceeds a depth threshold, and the determination that the foreground object in the zoomed preview is in-focus for the ToF based AF mode is based on a determination that the delta depth estimate exceeds the depth threshold.

In some embodiments, based on a determination that the foreground object in the zoomed preview is in-focus for the ToF based AF mode, bypassing a PDAF mode and activating the ToF based AF mode to focus on the foreground object, wherein the PDAF mode comprises focusing of the camera system based on the PDAF depth estimate, and wherein the ToF based AF mode comprises focusing of the camera system based on the ToF depth estimate.

Upon a determination that the delta depth estimate fails to exceed the depth threshold, the process proceeds to step 715, and the “Bypass PDAF” parameter is set to “FALSE” indicating that the PDAF mode remains active, and a ToF based AF mode is not activated.

Upon a determination that the delta depth estimate exceeds the depth threshold, the process proceeds to step 725.

At step 725, the process involves determining whether the ToF depth estimate is valid. For example, the ToF sensor may determine that an object is close, but the estimate may not be accurate. This may cause the ToF depth estimate to not be valid.

Upon a determination that the ToF depth estimate is not valid, the process proceeds to step 715, and the “Bypass PDAF” parameter is set to “FALSE” indicating that the PDAF mode remains active, and a ToF based AF mode is not activated.

Upon a determination that the ToF depth estimate is valid, the process proceeds to step 730.

At step 730, the process involves determining whether a brightness intensity of a background exceeds a brightness threshold.

Upon a determination that the brightness intensity of the background fails to exceed the brightness threshold, the process proceeds to step 715, and the “Bypass PDAF” parameter is set to “FALSE” indicating that the PDAF mode remains active, and a ToF based AF mode is not activated.

Upon a determination that the brightness intensity of the background exceeds the brightness threshold the process proceeds to step 735, and the “Bypass PDAF” parameter is set to “TRUE” indicating that the PDAF mode is bypassed, and the ToF based AF mode is activated.

FIG. 8A is another example workflow 800A for a hybrid auto-focus system with robust macro object priority focusing, in accordance with example embodiments. As illustrated, a hybrid AF macro object priority module 805 may be initiated. In some embodiments, the hybrid AF macro object priority module 805 may implement the autofocus aspects of the camera system.

At step 810, the process involves determining whether to bypass the PDAF mode. For example, the hybrid AF macro object priority module 805 may trigger the PDAF bypass determination module 705 illustrated in FIG. 7.

Upon a determination that the PDAF mode is not to be bypassed (e.g., workflow 700 terminates at step 715), the process proceeds to step 815. At step 815, the camera system uses a traditional hybrid AF strategy hierarchy involving applying a phase-detect autofocus (PDAF) algorithm, followed by a time-of-flight (ToF) based algorithm, and a contrast detection autofocus (CDAF) algorithm.

Upon a determination that the PDAF mode is to be bypassed (e.g., workflow 700 terminates at step 735), the process proceeds to step 820.

At step 820, the process involves determining whether the ToF depth estimate is valid, and whether the ToF depth estimate exceeds a ToF confidence threshold.

Upon a determination that the ToF depth estimate is valid, and that the ToF depth estimate exceeds the ToF confidence threshold, the process proceeds to step 825.

At step 825, the process involves focusing the camera system in the ToF based AF mode based on a distance-to-position mapping for a foreground object based on the ToF depth estimate.

In some embodiments, the ToF sensor may determine that an object is close, but the estimate may not be accurate, or may not be confident in a bright light setting Upon a determination that the ToF depth estimate is not valid, or that the ToF depth estimate fails to exceed the ToF confidence threshold, the process proceeds to step 830.

At step 830, the process involves focusing the camera system in the ToF based AF mode based on a multi-grid contrast detection autofocus (CDAF) search based on the ToF depth estimate. In some embodiments, the multi-grid CDAF search is based on one or more of a spatial grid, one or more directions, or one or more spatial frequencies. For example, two directions, one horizontal, and one vertical, may be used. Also, for example, the grid may be an M×N array.

FIG. 8B is an illustration of a multi-grid contrast detection autofocus (CDAF) analysis 800B, in accordance with example embodiments. As illustrated, a 5×5 grid 835 is shown for an image. Based on the 5×5 grid 835, one or more spatial frequencies (e.g., high, mid, etc.) may be determined, and one or more spatial directions (e.g., horizontal, vertical, etc.) may be used. For example, a 5×5 array of FV high frequencies 840 may be determined. Also, for example, a 5×5 array of FV mid frequencies 845 may be determined. For example, each subgrid in grid 835 corresponds to a high frequency distribution and a mid frequency distribution. Accordingly, each of high frequencies 840 and mid frequencies 845 comprise respective arrays of focus value (FV) curves. In some embodiments, the FV curves may be determined as a sum of the one or more directions (e.g., as a sum of the horizontal and vertical directions). However, other combinations may be used to generate the FV curves. The actual FV curves are not relevant for this discussion, and the curves shown are for illustrative purposes. Also, for example, although high and mid frequencies are illustrated, other frequencies may be utilized as well.

In some embodiments, the CDAF search may also include determining, for grid 835, a 5×5 array of peak to signal noise ratios (PSNR) 850, a 5×5 array of sharpness ratios 855, and a 5×5 array of peak focus positions 860, and so forth. The different intensities in PSNR 850, sharpness ratio 855, and peak focus position 860 may be represented by different colors, shading, and so forth. For example, a final focus position may be determined based on a weighted histogram analysis considering interpolated peaks from each grid, weighted by its FV curve quality metric, which could be represented as PSNR 850 or sharpness ratio 855. Additional and/or alternative quality factors may be used for determining quality metrics. For example, quality metrics may be based on one or more factors such as unimodality, accuracy, reproducibility, definition range, general applicability and robustness. In some embodiments, the final position may be determined based on a percentile from the histogram considering the depth-of-field (e.g. 33% for rule-of-thirds).

### Example Data Network

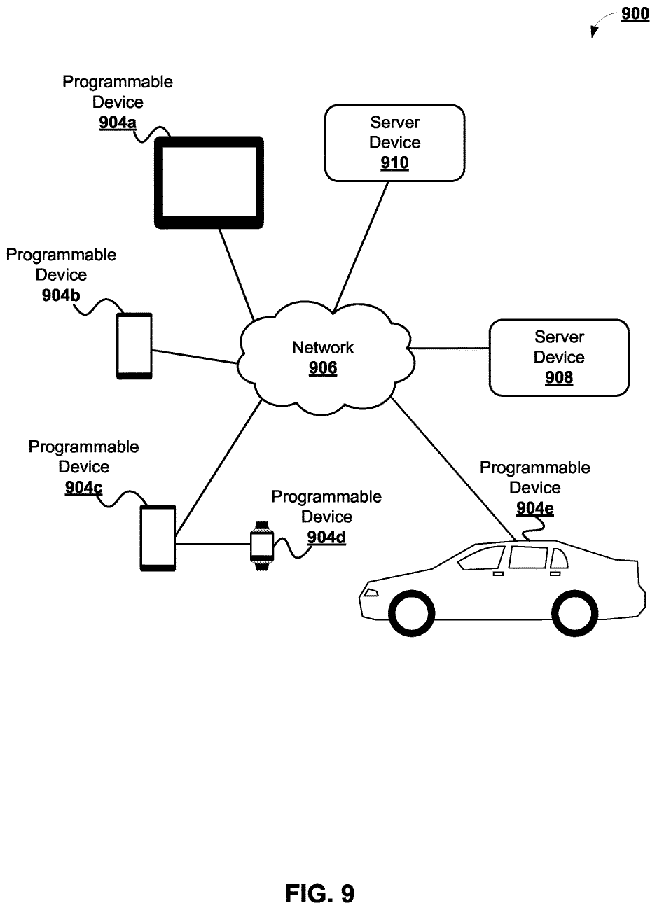

FIG. 9 depicts a distributed computing architecture 900, in accordance with example embodiments. Distributed computing architecture 900 includes server devices 908, 910 that are configured to communicate, via network 906, with programmable devices 904a, 904b, 904c, 904d, 904e. Network 906 may correspond to a local area network (LAN), a wide area network (WAN), a WLAN, a WWAN, a corporate intranet, the public Internet, or any other type of network configured to provide a communications path between networked computing devices. Network 906 may also correspond to a combination of one or more LANs, WANs, corporate intranets, and/or the public Internet.

Although FIG. 9 only shows five programmable devices, distributed application architectures may serve tens, hundreds, or thousands of programmable devices. Moreover, programmable devices 904a, 904b, 904c, 904d, 904e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 904a, 904b, 904c, 904e, programmable devices can be directly connected to network 906. In other examples, such as illustrated by programmable device 904d, programmable devices can be indirectly connected to network 906 via an associated computing device, such as programmable device 904c. In this example, programmable device 904c can act as an associated computing device to pass electronic communications between programmable device 904d and network 906. In other examples, such as illustrated by programmable device 904e, a computing device can be part of and/or inside a vehicle, such as a car, a truck, a bus, a boat or ship, an airplane, etc. In other examples not shown in FIG. 9, a programmable device can be both directly and indirectly connected to network 906.

Server devices 908, 910 can be configured to perform one or more services, as requested by programmable devices 904a-904e. For example, server device 908 and/or 910 can provide content to programmable devices 904a-904e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 908 and/or 910 can provide programmable devices 904a-904e with access to software for database, search, computation, graphical, audio, video, World Wide Web/Internet utilization, and/or other functions. Many other examples of server devices are possible as well.

### Computing Device Architecture

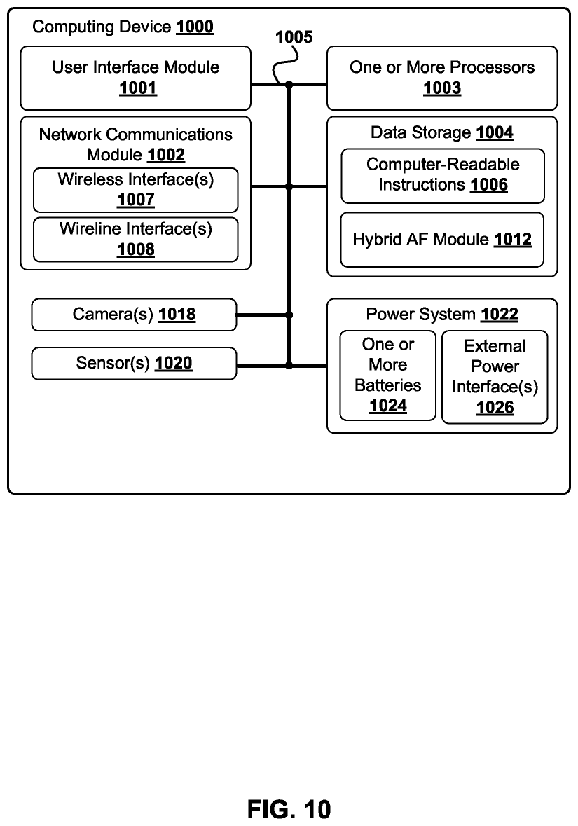

FIG. 10 is a block diagram of an example computing device 1000, in accordance with example embodiments. In particular, computing device 1000 shown in FIG. 10 can be configured to perform at least one function of and/or related to method 1100.

By way of example and without limitation, computing device 1000 may be a cellular mobile telephone (e.g., a smartphone), a still camera, a video camera, a fax machine, a computer (such as a desktop, notebook, tablet, or handheld computer), a personal digital assistant (PDA), a home automation component, a digital video recorder (DVR), a digital television, a remote control, a wearable computing device, or some other type of device equipped with at least some image capture and/or image processing capabilities. It should be understood that computing device 1000 may represent a physical camera device such as a digital camera, a particular physical hardware platform on which a camera application operates in software, or other combinations of hardware and software that are configured to carry out camera functions.

As shown in FIG. 10, computing device 1000 may include a user interface module 1001, a network communications module 1002, one or more processors 1003, data storage 1004, one or more cameras 1018, one or more sensors 1020, and power system 1022, all of which may be linked together via a system bus, network, or other connection mechanism 1005.

User interface module 1001 can be operable to send data to and/or receive data from external user input/output devices. For example, user interface module 1001 can be configured to send and/or receive data to and/or from user input devices such as a touch screen, a computer mouse, a keyboard, a keypad, a touch pad, a trackball, a joystick, a voice recognition module, and/or other similar devices. User interface module 1001 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1001 can also be configured to generate audible outputs, with devices such as a speaker, speaker jack, audio output port, audio output device, earphones, and/or other similar devices. User interface module 1001 can further be configured with one or more haptic devices that can generate haptic outputs, such as vibrations and/or other outputs detectable by touch and/or physical contact with computing device 1000. In some examples, user interface module 1001 can be used to provide a graphical user interface (GUI) for utilizing computing device 1000.

In some embodiments, user interface module 1001 may include a display that serves as a viewfinder for still camera and/or video camera functions supported by computing device 1000. Additionally, user interface module 1001 may include one or more buttons, switches, knobs, and/or dials that facilitate the configuration and focusing of a camera function and the capturing of images (e.g., capturing a picture). It may be possible that some or all of these buttons, switches, knobs, and/or dials are implemented by way of a presence-sensitive panel.

Network communications module 1002 can include one or more devices that provide one or more wireless interfaces 1007 and/or one or more wireline interfaces 1008 that are configurable to communicate via a network. Wireless interface(s) 1007 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1008 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1002 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1003 can include one or more general purpose processors, and/or one or more special purpose processors (e.g., digital signal processors, tensor processing units (TPUs), graphics processing units (GPUs), application specific integrated circuits, etc.). One or more processors 1003 can be configured to execute computer-readable instructions 1006 that are contained in data storage 1004 and/or other instructions as described herein.

Data storage 1004 can include one or more non-transitory computer-readable storage media that can be read and/or accessed by at least one of one or more processors 1003. The one or more computer-readable storage media can include volatile and/or non-volatile storage components, such as optical, magnetic, organic or other memory or disc storage, which can be integrated in whole or in part with at least one of one or more processors 1003. In some examples, data storage 1004 can be implemented using a single physical device (e.g., one optical, magnetic, organic or other memory or disc storage unit), while in other examples, data storage 1004 can be implemented using two or more physical devices.

Data storage 1004 can include computer-readable instructions 1006 and perhaps additional data. In some examples, data storage 1004 can include storage required to perform at least part of the herein-described methods, scenarios, and techniques and/or at least part of the functionality of the herein-described devices and networks. In some examples, data storage 1004 can include storage for a hybrid AF module 1012 (e.g., a module that performs the hybrid AF macro object priority procedure, and computes the PDAF algorithm, ToF algorithm, CDAF algorithm, and so forth, and executes one of more operations related to the hybrid auto-focus system with robust macro object priority focusing as described herein). In particular of these examples, computer-readable instructions 1006 can include instructions that, when executed by processor(s) 1003, enable computing device 1000 to provide for some or all of the functionality of hybrid AF 1012.

In some examples, computing device 1000 can include one or more cameras 1018. Camera(s) 1018 can include one or more image capture devices, such as still and/or video cameras, equipped to capture light and record the captured light in one or more images; that is, camera(s) 1018 can generate image(s) of captured light. The one or more images can be one or more still images and/or one or more images utilized in video imagery. Camera(s) 1018 can capture light and/or electromagnetic radiation emitted as visible light, infrared radiation, ultraviolet light, and/or as one or more other frequencies of light. Camera(s) 1018 can include a wide camera, a tele camera, an ultrawide camera, and so forth. Also, for example, camera(s) 1018 can be front-facing or rear-facing cameras with reference to computing device 1000. Camera(s) 1018 can include camera components such as, but are not limited to, an aperture, shutter, recording surface (e.g., photographic film and/or an image sensor), lens, and/or shutter button. The camera components may be controlled at least in part by software executed by one or more processors 1003.

In some examples, computing device 1000 can include one or more sensors 1020. Sensors 1020 can be configured to measure conditions within computing device 1000 and/or conditions in an environment of computing device 1000 and provide data about these conditions. For example, sensors 1020 can include one or more of: (i) sensors for obtaining data about computing device 1000, such as, but not limited to, a thermometer for measuring a temperature of computing device 1000, a battery sensor for measuring power of one or more batteries of power system 1022, and/or other sensors measuring conditions of computing device 1000; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1000, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1000, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1000, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1020 are possible as well.

Power system 1022 can include one or more batteries 1024 and/or one or more external power interfaces 1026 for providing electrical power to computing device 1000. Each battery of the one or more batteries 1024 can, when electrically coupled to the computing device 1000, act as a source of stored electrical power for computing device 1000. One or more batteries 1024 of power system 1022 can be configured to be portable. Some or all of one or more batteries 1024 can be readily removable from computing device 1000. In other examples, some or all of one or more batteries 1024 can be internal to computing device 1000, and so may not be readily removable from computing device 1000. Some or all of one or more batteries 1024 can be rechargeable. For example, a rechargeable battery can be recharged via a wired connection between the battery and another power supply, such as by one or more power supplies that are external to computing device 1000 and connected to computing device 1000 via the one or more external power interfaces. In other examples, some or all of one or more batteries 1024 can be non-rechargeable batteries.

One or more external power interfaces 1026 of power system 1022 can include one or more wired-power interfaces, such as a USB cable and/or a power cord, that enable wired electrical power connections to one or more power supplies that are external to computing device 1000. One or more external power interfaces 1026 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1026, computing device 1000 can draw electrical power from the external power source the established electrical power connection. In some examples, power system 1022 can include related sensors, such as battery sensors associated with the one or more batteries or other types of electrical power sensors.

### Example Methods of Operation

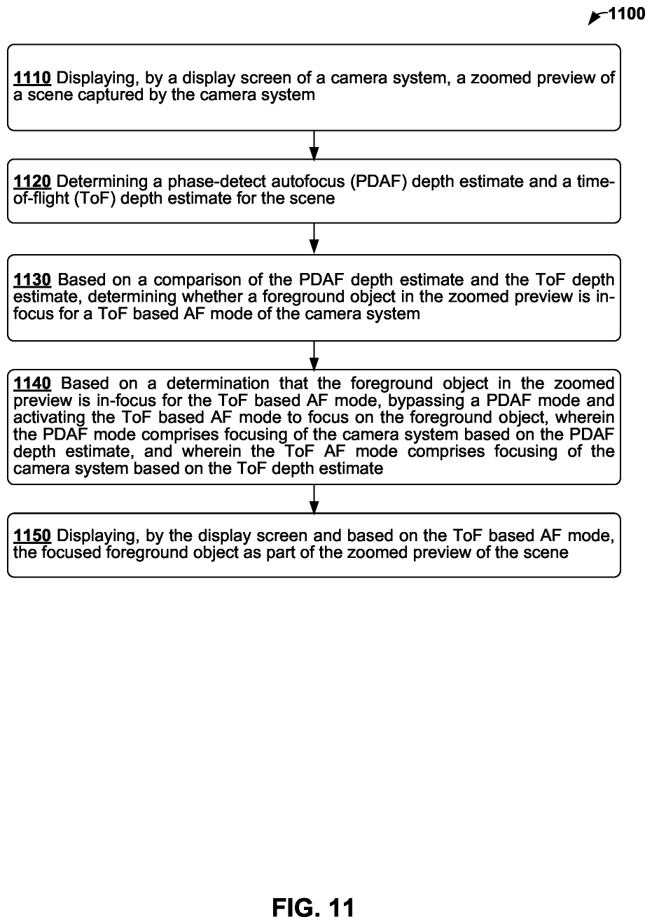

FIG. 11 illustrates a method 1100, in accordance with example embodiments. Method 1100 may include various blocks or steps. The blocks or steps may be carried out individually or in combination. The blocks or steps may be carried out in any order and/or in series or in parallel. Further, blocks or steps may be omitted or added to method 1100.

The blocks of method 1100 may be carried out by various elements of computing device 1000 as illustrated and described in reference to FIG. 10.

Block 1110 includes displaying, by a display screen of a camera system, a zoomed preview of a scene captured by the camera system.

Block 1120 includes determining a phase-detect autofocus (PDAF) depth estimate and a time-of-flight (ToF) depth estimate for the scene.

Block 1130 includes, based on a comparison of the PDAF depth estimate and the ToF depth estimate, determining whether a foreground object in the zoomed preview is in-focus for a ToF based AF mode of the camera system.

Block 1140 includes, based on a determination that the foreground object in the zoomed preview is in-focus for the ToF based AF mode, bypassing a PDAF mode and activating the ToF based AF mode to focus on the foreground object, wherein the PDAF mode comprises focusing of the camera system based on the PDAF depth estimate, and wherein the ToF based AF mode comprises focusing of the camera system based on the ToF depth estimate.

Block 1150 includes displaying, by the display screen and based on the ToF based AF mode, the focused foreground object as part of the zoomed preview of the scene.

Some embodiments involve, based on a second comparison of a second PDAF depth estimate and a second ToF depth estimate, determining that a second foreground object in a second zoomed preview of the scene is not in-focus for the ToF based AF mode. Such embodiments involve, based on the determination that the second foreground object in the second zoomed preview of the scene is not in-focus for the ToF based AF mode, maintaining the PDAF mode and not activating the ToF based AF mode, and wherein the displaying comprises displaying the second zoomed preview based on the PDAF mode.

In some embodiments, the comparison of the PDAF depth estimate and the ToF depth estimate involves determining whether a delta depth estimate based on a difference between the PDAF depth estimate and the ToF depth estimate exceeds a depth threshold, and wherein the determination that the foreground object in the zoomed preview is in-focus for the ToF based AF mode is based on a determination that the delta depth estimate exceeds the depth threshold.

In some embodiments, the receiving of the PDAF depth estimate involves determining whether the PDAF depth estimate exceeds a PDAF confidence threshold, and wherein the bypassing of the PDAF mode is based on the determination whether the PDAF depth estimate exceeds the PDAF confidence threshold.

Such embodiments involve receiving a second PDAF depth estimate based on a second zoomed preview of the scene. Such embodiments involve determining that the second PDAF depth estimate does not exceed the PDAF confidence threshold. Such embodiments also involve maintaining the PDAF mode and not activating the ToF based AF mode, and wherein the displaying comprises displaying the second zoomed preview based on the PDAF mode.

In some embodiments, the the receiving of the ToF depth estimate involves determining whether the ToF depth estimate exceeds a ToF confidence threshold, and wherein the focusing of the camera system in the ToF based AF mode is based on the determination whether the ToF depth estimate exceeds the ToF confidence threshold.

Such embodiments involve determining that the ToF depth estimate exceeds the ToF confidence threshold, and wherein the focusing of the camera system in the ToF based AF mode is based on a distance-to-position mapping for the foreground object based on the ToF depth estimate.

Some embodiments involve determining that the ToF depth estimate does not exceed the ToF confidence threshold, and wherein the focusing of the camera system in the ToF based AF mode is based on a multi-grid contrast detection autofocus (CDAF) search based on the ToF depth estimate. In some embodiments, the multi-grid CDAF search is based on one or more of a spatial grid, one or more directions, or one or more spatial frequencies.

Some embodiments involve receiving a second ToF depth estimate based on a second zoomed preview of the scene. Such embodiments involve determining that the second ToF depth estimate does not exceed a ToF confidence threshold. Such embodiments also involve maintaining the PDAF mode and not activating the ToF based AF mode, and wherein the displaying comprises displaying the second zoomed preview based on the PDAF mode.

Some embodiments involve determining that the PDAF depth estimate exceeds a PDAF confidence threshold. Such embodiments involve determining that the ToF depth estimate exceeds a ToF confidence threshold. Such embodiments also involve determining, based on the zoomed preview of the scene, whether a brightness intensity of a background exceeds a brightness threshold, and wherein the bypassing of the PDAF mode is based on the determination whether the brightness intensity of the background exceeds the brightness threshold.

Some embodiments involve determining that the brightness intensity of the background exceeds the brightness threshold. Such embodiments involve bypassing the PDAF mode and activating the ToF based AF mode.

Some embodiments involve determining that a second brightness intensity of a second background in a second zoomed preview does not exceed the brightness threshold. Such embodiments involve maintaining the PDAF mode and not activating the ToF based AF mode, and wherein the displaying comprises displaying the second zoomed preview based on the PDAF mode.

Some embodiments involve receiving, by a user interface of the display screen, an indication to disable the ToF based AF mode. Such embodiments involve, responsive to the indication, maintaining the PDAF mode and not activating the ToF based AF mode, and wherein the displaying comprises displaying a second zoomed preview based on the PDAF mode.

Some embodiments involve displaying, by the display screen, an initial preview of the scene being captured by another camera system, the other camera system operating at another focal length greater than or equal to the threshold focal length. Such embodiments involve detecting a zoom operation that causes a transition from the second camera system to the camera system. Some embodiments also involve providing, by a user interface of the display screen, a selectable virtual object to receive an indication whether to enable or disable the ToF based AF mode. In such embodiments, the camera system is configured to provide an ultra-wide field of view (FOV), and wherein the other camera system is configured to provide a wide FOV.

For example, the camera system may automatically switch to an ultra-wide angle (UWA) camera (e.g., cropped to 1×) when a user moves closer than 15 centimeters (cm) to an object. In some embodiments, a button in the user interface signifying Macro Mode may appear and may be highlighted. In the event the button is pressed while in Macro Mode (e.g., less than 18 cm. away), the UWA camera may be disengaged, and the camera system may revert back to the main sensor. Also, for example, pressing a button (e.g., 0.7× may disengage the Macro Mode and switch back to normal UWA view. In the event the user moves away from the object (e.g., greater than 18 cm.), the camera system automatically switches back to the main sensor.

In some embodiments, the focusing of the camera system comprises adjusting at least one lens of the camera system.

In some embodiments, the focusing of the camera system comprises determining an exposure time for the camera system based on a motion-blur tolerance of the camera system.

In some embodiments, the camera system is a component of a mobile device.

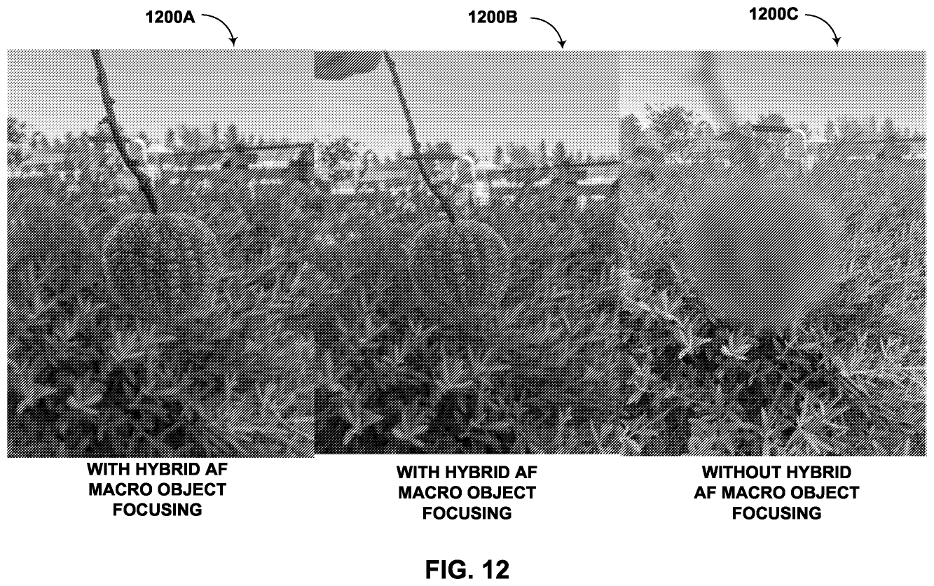

FIG. 12 illustrates a difference in image focusing with and without the hybrid AF based macro object focusing, in accordance with example embodiments. Images 1200A and 1200 B correspond to camera systems where the hybrid AF based macro object focusing is activated. Upon a transition to an ultra-wide camera (e.g., from a main camera), the camera system is able to detect intensity peaks corresponding to close-up objects. However, as illustrated by image 1200C, for a camera system where the hybrid AF based macro object focusing is not activated, upon a transition to an ultra-wide camera, the camera system focuses on the background, and is not able to focus on foreground objects.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A computer-implemented method, comprising:
displaying, by a display screen of a camera system, a zoomed preview of a scene captured by the camera system;
determining a phase-detect autofocus (PDAF) depth estimate and a time-of-flight (ToF) depth estimate for the scene;
based on a comparison of the PDAF depth estimate and the ToF depth estimate, determining whether a foreground object in the zoomed preview is in-focus for a ToF based AF mode of the camera system;
based on a determination that the foreground object in the zoomed preview is in-focus for the ToF based AF mode, bypassing a PDAF mode and activating the ToF based AF mode to focus on the foreground object, wherein the PDAF mode comprises focusing of the camera system based on the PDAF depth estimate, and wherein the ToF based AF mode comprises focusing of the camera system based on the ToF depth estimate; and
displaying, by the display screen and based on the ToF based AF mode, the focused foreground object as part of the zoomed preview of the scene.

2. The method of claim 1, further comprising:
based on a second comparison of a second PDAF depth estimate and a second ToF depth estimate, determining that a second foreground object in a second zoomed preview of the scene is not in-focus for the ToF based AF mode; and
based on the determination that the second foreground object in the second zoomed preview of the scene is not in-focus for the ToF based AF mode, maintaining the PDAF mode and not activating the ToF based AF mode, and
wherein the displaying comprises displaying the second zoomed preview based on the PDAF mode.

3. The method of claim 1, wherein the comparison of the PDAF depth estimate and the ToF depth estimate comprises:
determining whether a delta depth estimate based on a difference between the PDAF depth estimate and the ToF depth estimate exceeds a depth threshold, and
wherein the determination that the foreground object in the zoomed preview is in-focus for the ToF based AF mode is based on a determination that the delta depth estimate exceeds the depth threshold.

4. The method of claim 1, wherein the receiving of the PDAF depth estimate further comprises:
determining whether the PDAF depth estimate exceeds a PDAF confidence threshold, and
wherein the bypassing of the PDAF mode is based on the determination whether the PDAF depth estimate exceeds the PDAF confidence threshold.

5. The method of claim 4, further comprising:
receiving a second PDAF depth estimate based on a second zoomed preview of the scene;
determining that the second PDAF depth estimate does not exceed the PDAF confidence threshold; and
maintaining the PDAF mode and not activating the ToF based AF mode, and
wherein the displaying comprises displaying the second zoomed preview based on the PDAF mode.

6. The method of claim 1, wherein the receiving of the ToF depth estimate further comprises:
determining whether the ToF depth estimate exceeds a ToF confidence threshold, and
wherein the focusing of the camera system in the ToF based AF mode is based on the determination whether the ToF depth estimate exceeds the ToF confidence threshold.

7. The method of claim 6, further comprising:
determining that the ToF depth estimate exceeds the ToF confidence threshold, and
wherein the focusing of the camera system in the ToF based AF mode is based on a distance-to-position mapping for the foreground object based on the ToF depth estimate.

8. The method of claim 6, further comprising:
determining that the ToF depth estimate does not exceed the ToF confidence threshold, and
wherein the focusing of the camera system in the ToF based AF mode is based on a multi-grid contrast detection autofocus (CDAF) search based on the ToF depth estimate.

9. The method of claim 8, wherein the multi-grid CDAF search is based on one or more of a spatial grid, one or more directions, or one or more spatial frequencies.

10. The method of claim 1, further comprising:
receiving a second ToF depth estimate based on a second zoomed preview of the scene;
determining that the second ToF depth estimate does not exceed a ToF confidence threshold; and
maintaining the PDAF mode and not activating the ToF based AF mode, and
wherein the displaying comprises displaying the second zoomed preview based on the PDAF mode.

11. The method of claim 1, further comprising:
determining that the PDAF depth estimate exceeds a PDAF confidence threshold;
determining that the ToF depth estimate exceeds a ToF confidence threshold;
determining, based on the zoomed preview of the scene, whether a brightness intensity of a background exceeds a brightness threshold, and
wherein the bypassing of the PDAF mode is based on the determination whether the brightness intensity of the background exceeds the brightness threshold.

12. The method of claim 11, further comprising:
determining that the brightness intensity of the background exceeds the brightness threshold; and
bypassing the PDAF mode and activating the ToF based AF mode.

13. The method of claim 11, further comprising:
determining that a second brightness intensity of a second background in a second zoomed preview does not exceed the brightness threshold; and
maintaining the PDAF mode and not activating the ToF based AF mode, and
wherein the displaying comprises displaying the second zoomed preview based on the PDAF mode.

14. The method of claim 1, further comprising:
receiving, by a user interface of the display screen, an indication to disable the ToF based AF mode; and
responsive to the indication, maintaining the PDAF mode and not activating the ToF based AF mode, and
wherein the displaying comprises displaying a second zoomed preview based on the PDAF mode.

15. The method of claim 1, further comprising:
displaying, by the display screen, an initial preview of the scene being captured by another camera system;
detecting a zoom operation that causes a transition from the second camera system to the camera system; and
providing, by a user interface of the display screen, a selectable virtual object to receive an indication whether to enable or disable the ToF based AF mode.

16. The method of claim 15, wherein the camera system is configured to provide an ultrawide field of view (FOV), and wherein the other camera system is configured to provide a wide FOV.

17. The method of claim 1, wherein the focusing of the camera system comprises adjusting at least one lens of the camera system.

18. The method of claim 1, wherein the focusing of the camera system comprises determining an exposure time for the camera system based on a motion-blur tolerance of the camera system.

19. The method of claim 1, wherein the camera system is a component of a mobile device.

20. A computing device, comprising:
a display screen;
a camera system configured to operate at a focal length less than a threshold focal length;
one or more processors; and
data storage, wherein the data storage has stored thereon computer-executable instructions that, when executed by the one or more processors, cause the mobile device to carry out functions comprising:
displaying, by a display screen of the camera system, a zoomed preview of a scene captured by the camera system;
determining a phase-detect autofocus (PDAF) depth estimate and a time-of-flight (ToF) depth estimate for the scene;
based on a comparison of the PDAF depth estimate and the ToF depth estimate, determining whether a foreground object in the zoomed preview is in-focus for a ToF based AF mode of the camera system;
based on a determination that the foreground object in the zoomed preview is in-focus for the ToF based AF mode, bypassing a PDAF mode and activating the ToF based AF mode to focus on the foreground object, wherein the PDAF mode comprises focusing of the camera system based on the PDAF depth estimate, and wherein the ToF based AF mode comprises focusing of the camera system based on the ToF depth estimate; and
displaying, by the display screen and based on the ToF based AF mode, the focused foreground object as part of the zoomed preview of the scene.

21. A non-transitory computer-readable medium comprising program instructions executable by one or more processors to cause the one or more processors to perform operations comprising:
displaying, by a display screen of a camera system, a zoomed preview of a scene captured by the camera system;
determining a phase-detect autofocus (PDAF) depth estimate and a time-of-flight (ToF) depth estimate for the scene;
based on a comparison of the PDAF depth estimate and the ToF depth estimate, determining whether a foreground object in the zoomed preview is in-focus for a ToF based AF mode of the camera system;
based on a determination that the foreground object in the zoomed preview is in-focus for the ToF based AF mode, bypassing a PDAF mode and activating the ToF based AF mode to focus on the foreground object, wherein the PDAF mode comprises focusing of the camera system based on the PDAF depth estimate, and wherein the ToF based AF mode comprises focusing of the camera system based on the ToF depth estimate; and
displaying, by the display screen and based on the ToF based AF mode, the focused foreground object as part of the zoomed preview of the scene.
